(19) United States
(12) Patent Application Publication
(10) Pub. No.: US 2026/0316839 A1
(43) Pub. Date: Oct. 15, 2026

(54) Off-Road Vehicle

(71) Applicant: Zhejiang CFMOTO Power Co., Ltd., Hangzhou (CN)

(72) Inventors: Yipeng Yin, Hangzhou (CN); Zewei Hu, Hangzhou (CN); Jin Li, Hangzhou (CN)

(21) Appl. No.: 19/696,554

(22) Filed: Jun. 3, 2026

Related U.S. Application Data
(63) Continuation of application No. PCT/CN2024/094343, filed on May 21, 2024.

(30) Foreign Application Priority Data
Dec. 4, 2023 (CN) 202311670716.8

(51) Int. Cl. B62D 23/00; B60K 1/04

(52) U.S. Cl. CPC B62D 23/005; B60K 1/04; B60K 2001/0416

(57) ABSTRACT

An off-road vehicle includes a prime mover assembly with a drive motor, and also includes a power battery, both positioned rearward of seating. When viewed from a length direction of the off-road vehicle, both the power battery and a rear cargo area at least partially overlap with the seating. When viewed from a height direction of the off-road vehicle, the rear cargo area at least partially overlaps with the power battery and the drive motor. The off-road vehicle further includes a back panel at least partially positioned between the power battery and the seating. The back panel has a maintenance opening defined therein for accessing the power battery.

### RELATED APPLICATION INFORMATION

The present application is a continuation of PCT/CN2024/094343 filed May 21, 2024, and claims the benefits of priority to Chinese Patent Application No. 202311670716.8, filed with the Chinese Patent Office on Dec. 4, 2023 and entitled “Off-road Vehicle”. The entire contents of the above-referenced applications are incorporated herein by reference.

### FIELD OF THE DISCLOSURE

The application refers to the field of vehicles, and particularly to a type of off-road vehicle.

### BACKGROUND OF THE DISCLOSURE

In existing electric off-road vehicles, the battery is generally arranged under the chassis of the vehicle or above the chassis of the vehicle, i.e., the battery is generally arranged under the seats. However, such arrangement results in a smaller space under the seats, thereby making the cockpit space smaller, which is not conducive to improving the space utilization of the off-road vehicle, and further affects the structural compactness of the off-road vehicle.

In addition, for small off-road vehicles such as those intended to be driven by minor children, their compact size makes the arrangement of the battery significantly affect the structural compactness. In view of the above, how to reasonably arrange the battery to improve the structural compactness of off-road vehicles is an urgent problem to be solved.

### SUMMARY OF THE INVENTION

To address the deficiencies of prior art the present invention aims to provide an all-terrain vehicle with a compact structure.

To achieve the above objective, the present application adopts the following technical solution:

An off-road vehicle includes a frame, seating, a plurality of wheels, a suspension system, a prime mover assembly, a power battery, and a rear cargo area. The frame has a middle frame at least partially defining a cockpit, and a front frame forward of the middle frame and a rear frame rearward of the middle frame. The seating is supported by the middle frame. The plurality of wheels support the frame and include a pair of front wheels and a pair of rear wheels. The front wheels and the rear wheels are connected to the frame by the suspension system. The prime mover assembly is supported by the rear frame, and includes a drive motor coupled to transmit torque to at least one of the pair of front wheels and the pair of rear wheels. The power battery is supported by the rear frame and electrically connected to provide electricity to the drive motor of the prime mover assembly. The rear cargo area is at least partially disposed on the rear frame.

In one aspect, when viewed from a length direction of the off-road vehicle, both the power battery and the rear cargo area at least partially overlap with the seating. When viewed from a height direction of the off-road vehicle, the rear cargo area at least partially overlaps with the power battery and the drive motor. The power battery is at least partially positioned under the rear cargo area and the drive motor is at least partially positioned under the power battery.

In another aspect, the off-road vehicle further includes a back panel at least partially positioned between the power battery and the seating. The back panel has a maintenance opening defined therein for accessing the power battery.

The details of one or more embodiments of the present invention are set forth in the accompanying drawings and the description below. Other features, objects, and advantages of the present application will become apparent from the description, drawings, and claims.

### BRIEF DESCRIPTION OF THE DRAWINGS

FIG. 1 is a rear right perspective view of an off-road vehicle in accordance with a preferred embodiment of the present invention.

FIG. 2 is a rear right perspective view of the front frame, middle frame and rear frame of the off-road vehicle of FIG. 1, together with the rear suspension, drive motor and a portion of the drive train of the off-road vehicle of FIG. 1.

FIG. 3 is a left side cross-section view of the portions of the off-road vehicle shown in FIG. 2, but omitting the rear suspension and instead showing the power battery and rear cargo area and schematically showing the wheels of the off-road vehicle of FIG. 1.

FIG. 4 is an enlarged view of portion 4 in FIG. 1.

FIG. 5 is a left side partial view of rear portions of off-road vehicle shown in FIG. 3, and further showing the rear suspension.

FIG. 6 is the rear right perspective view of FIG. 2, further showing the power battery, seating and back panel of the off-road vehicle of FIG. 1 in exploded rear right perspective view.

FIG. 7 is a front right perspective view of the components of FIG. 6 as assembled, omitting the passenger seat back.

FIG. 8 is a top plan view showing layout of the drive motor, portions of the drive train, and the rear wheels of the off-road vehicle of FIG. 1.

FIG. 9 is an enlarged view of portion 9 in FIG. 2.

FIG. 10 is a partial rear right perspective view of the front frame, middle frame, rear frame and suspension system of the off-road vehicle of FIG. 1, showing the right side of the rear suspension in exploded rear right perspective view.

FIG. 11 is a top plan view of the rear frame and rear suspension of the off-road vehicle of FIG. 1, omitting the rear shock absorbers and rear sway bar.

FIG. 12 is a right side view of the front frame, front suspension and steering system of the off-road vehicle of FIG. 1, also showing part of the middle frame.

FIG. 13 is an enlarged view of portion 13 in FIG. 12.

FIG. 14 is a front right perspective view of portions of FIG. 12, showing portions of the steering system in exploded front right perspective view.

FIG. 15 is an exploded view of a passenger grabhandle relative to the front frame and part of the middle frame of the off-road vehicle of FIG. 1.

FIG. 16 is a right side view of the frame, wheels and rear suspension of the off-road vehicle of FIG. 1.

### DETAIL DESCRIPTION

To enable those skilled in the art to better understand the solution of the present invention, the technical solutions in the specific embodiments of the present application will be clearly and completely described below with reference to the accompanying drawings.

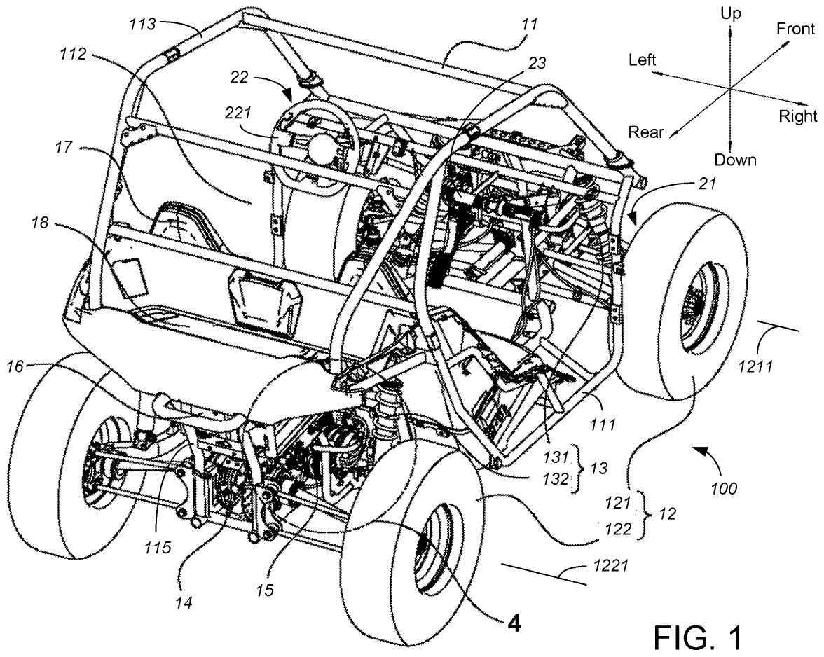

FIG. 1 shows an off-road vehicle 100 in accordance with a preferred embodiment of the present invention. The off-road vehicle 100 includes a frame 11, a plurality of wheels 12, a suspension system 13, a drive train 14, a prime mover assembly 15, a power battery 16, seating 17, and a rear cargo area 18. The frame 11 serves as a basic connection framework of the off-road vehicle 100 and is used to support the drive train 14, the prime mover assembly 15, the power battery 16, the seating 17, and the rear cargo area 18. The plurality of wheels 12 include left and right front wheels 121 which rotate (when the off-road vehicle 100 is moving and not turning) generally about a front wheel axis 1211 and left and right rear wheels 122 which rotate generally about a rear wheel axis 1221. The suspension system 13 connects the wheels 12 to the frame 11 and supports the frame 11 from the wheels 12. The suspension system 13 includes a front suspension 131 connecting the front wheels 121 to the frame 11 and a rear suspension 132 connecting the rear wheels 122 to the frame 11. The prime mover assembly 15 is drivingly connected to at least one set of the front wheels 121 and the rear wheels 122 via the drive train 14, so that the prime mover assembly 15 can drive the off-road vehicle 100 to move forwardly or in reverse through the plurality of wheels 12. The power battery 16 is disposed on the frame 11 and is electrically connected to the prime mover assembly 15. The off-road vehicle 100 is preferably an electric vehicle, and electricity supplied from the power battery 16 allows the prime mover assembly 15 to output torque to the drive train 14 for movement of the off-road vehicle 100. The seating 17 is at least partially disposed on the frame 11 to support a driver and/or passenger(s) in a seated position. The rear cargo area 18 is at least partially disposed on the frame 11, and the rear cargo area 18 is used for carrying cargo. The seating 17 is preferably a configured as single-row to save layout space of the off-road vehicle 100, thereby providing sufficient layout space for the rear cargo area 18 and further improving the structural compactness of the off-road vehicle 100.

To clearly illustrate the technical solution of the present application, directions of front, rear, left, right, up and down are shown in FIG. 1, generally discussed assuming the off-road vehicle 100 is on flat ground. The terms “length” and “longitudinal” are used herein referring to the front-rear direction of the off-road vehicle 100, the terms “height” and “vertical” are used herein referring to the up-down direction of the off-road vehicle 100, and terms “width”, “transverse” and “lateral” are used herein referring to the left-right direction of the off-road vehicle 100.

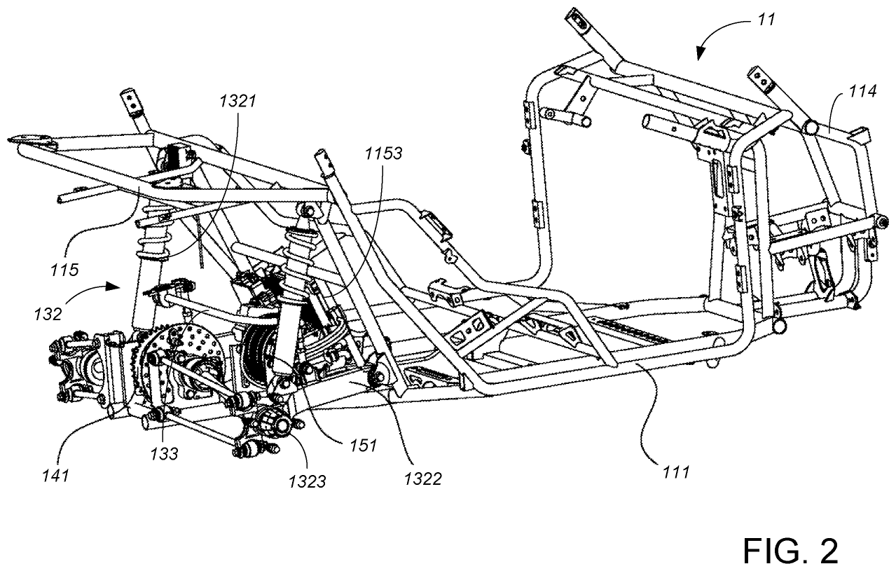

The prime mover assembly 15 includes a drive motor 151 as shown in FIGS. 2-6, 8 and 9. The preferred embodiment shown in the drawings is a rear-wheel drive off-road vehicle 100 provided as an example, in which the drive train 14 provides torque from the drive motor 151 to the rear wheels 122. However, front wheel drive and four wheel drive off-road vehicles are also contemplated.

When viewed from the length direction of the off-road vehicle 100 (such as in front view), the drive motor 151 at least partially overlaps with the seating 17, the power battery 16 at least partially overlaps with the seating 17, and the rear cargo area 18 at least partially overlaps with the seating 17. When viewed from the height direction of the off-road vehicle 100 (such as in top plan view), the rear cargo area 18 at least partially overlaps with the power battery 16, and both the rear cargo area 18 and the power battery 16 at least partially overlap with the drive motor 151. Further, when viewed from the height direction of the off-road vehicle 100 (such as in top plan view), the power battery 16 preferably at least partially overlaps with the rear wheel axis 1221, while the drive motor 151 is positioned forwardly of the rear wheel axis 1221. The rear cargo area 18, the power battery 16 and the drive motor 151 are all disposed rearwardly of the seating 17. Elevationally, the power battery 16 is at least partially positioned lower than the rear cargo area 18, and the power battery 16 is at least partially positioned higher than the drive motor 151 and the rear wheel axis 122. That is, along the height direction of the off-road vehicle 100, the power battery 16 is substantially positioned between the rear cargo area 18 and both the drive motor 151 and the rear wheel axis 122.

The frame 11 includes a middle frame 111 at least partially defining a cockpit 112, with the seating 17 positioned in the cockpit 112. The cockpit 112 is preferably protected by a roll-over protection system 113 (ROPS) that extends over the cockpit 112. The frame 11 also includes a front frame 114 positioned forwardly of the middle frame 111 and a rear frame 115 positioned rearwardly of the middle frame 111. The power battery 16 and the rear cargo area 18 are both supported by the rear frame 115.

Through the above arrangement, space utilization of the rear frame 115 is improved, allowing the rear frame 115 to be more compact and lightweight. At the same time, the cockpit 112 can maintain ample and comfortable riding space for the driver and passenger(s), without excessive height. Meanwhile, positioning the power battery 16 rearward of the cockpit 112 keeps heat (generated by the power battery 16 during working) away from the cockpit 112, further improving comfort of the off-road vehicle 100. The length of the drive train 14 between the drive motor 151 and the rear wheels 122 is low, keeping the drive train 14 compact, and reducing power loss during transmission. The distance between the drive motor 151 and the power battery 16 is low, thereby shortening the length of wiring (not shown) between the drive motor 151 and the power battery 16 and improving energy efficiency. Furthermore, working space of the rear suspension 133 can be increased without interference between the rear suspension 132 and other components of the off-road vehicle 100, thereby improving the driving performance of the off-road vehicle 100.

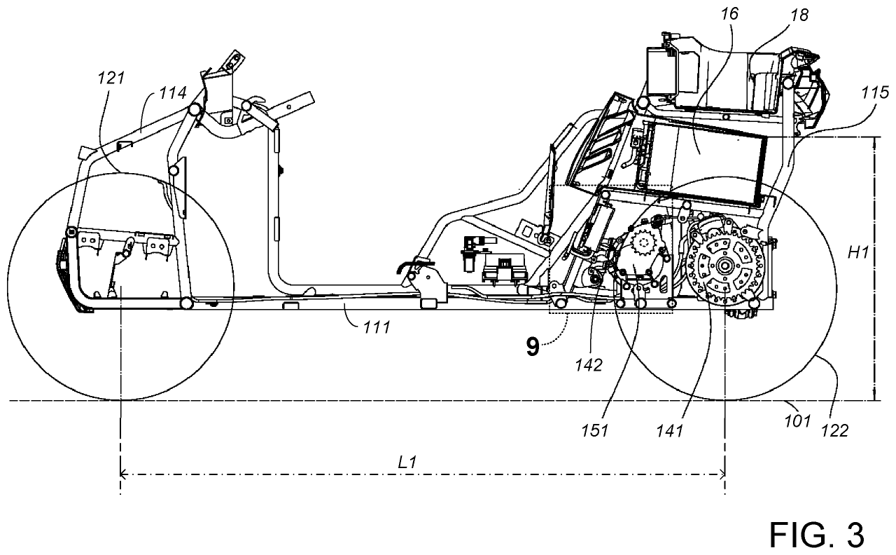

A ground plane 101 is defined as a plane perpendicular to the height direction of the off-road vehicle 100 at the lowest ends of the plurality of wheels 12 as shown in FIG. 3. The minimum vertical distance between an upper surface of the power battery 16 and the ground plane 101 is defined as battery height H1. This minimum vertical distance of the battery height H1 preferably occurs at the rear end of the power battery 16. Horizontal distance from the front wheel axis 1211 to the rear wheel axis 1221 is defined as a wheelbase L1. A battery height/wheelbase ratio H1/L1 of the battery height H1 to the wheelbase L1 is preferably in the range of 0.3 to 0.58, more preferably in the range of 0.37 to 0.51, and most preferably about 0.44. Values for battery height/wheelbase ratio H1/L1 within the preferred ranges help avoid interference between the power battery 16 and other components in the rear frame 115, preventing damage to the power battery 16 that could cause safety hazards, and improving operational stability of the power battery 16. Values for battery height/wheelbase ratio H1/L1 within the preferred ranges also allow for a low center of gravity for the off-road vehicle 100 while ensuring good wading capability of the power battery 16 and off-road vehicle 100, useful for when the off-road vehicle crosses streams, puddles or mud bogs.

A projection of the power battery 16 vertically onto the ground plane 101 is defined as a power battery projection, and a projection of the rear cargo area 18 vertically onto the ground plane 101 is defined as a cargo box projection. A power battery/cargo box area ratio of an area of the power battery projection to an area of the cargo box projection is preferably in the range from 0.3 to 0.56, more preferably in the range from 0.36 to 0.5, and most preferably about 0.43. If the power battery/cargo box area ratio is too large, the power battery 16 can take up too much area under the cargo box, and the space available for mounting other components will be decreased. If power battery/cargo box area ratio is too small, the power battery 16 likely requires excessive height relative to range (maximum distance the off-road vehicle can travel without recharging of the power battery 16) and/or provides insufficient range of the off-road vehicle 100.

A projection of the drive motor 151 vertically onto the ground plane 101 is defined as a drive motor projection. A drive motor/cargo box area ratio of an area of the drive motor projection to an area of the cargo box projection is preferably in the range from 0.06 to 0.13, more preferably in the range from 0.07 to 0.11, and most preferably about 0.09. A drive motor/power battery area ratio of an area of the drive motor projection to an area of the power battery projection is preferably in the range from 0.14 to 0.27, more preferably in the range from 0.17 to 0.24, and most preferably about 0.2. The drive motor 151 is typically substantially cylindrical, with the drive motor projection being indicative of the power output of the drive motor 151. An appropriate drive motor/power battery area ratio helps select appropriate battery storage capacity for high output power, while having both the drive motor 151 and the power battery 16 occupy no more space than necessary on the rear frame 115 and improving space utilization rate of the drive motor 151 and power battery 16.

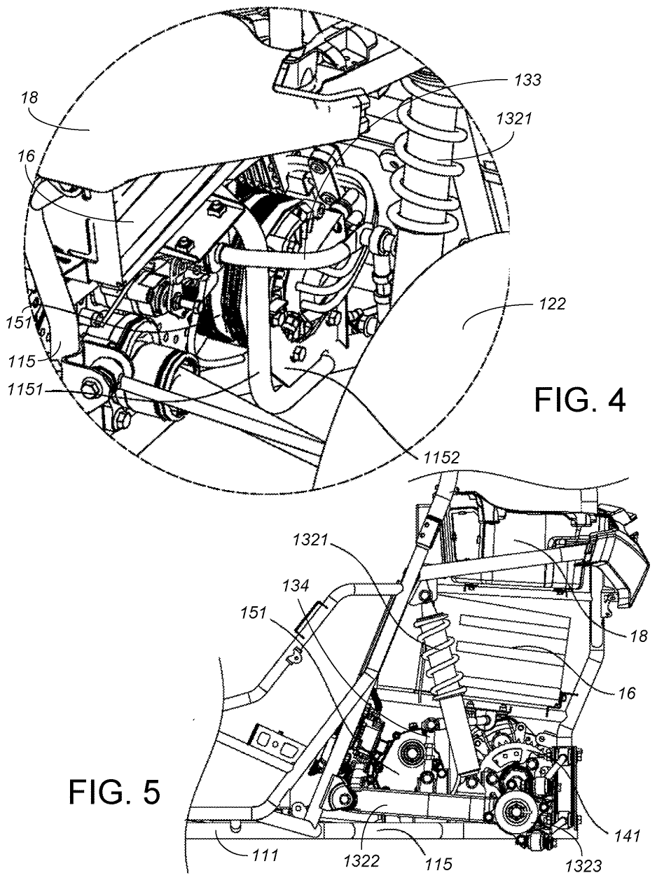

FIG. 4 enlarges a portion of FIG. 1, focusing on a motor mounting bracket 1151 and a motor connection panel 1152 of the rear frame 115. The motor mounting bracket 1151 and the motor connection panel 1152 both extend at least partially vertically. The motor connection panel 1152 is connected to the motor mounting bracket 1151 such as by welding or by bolts. The drive motor 151 is at least partially connected to the motor connection panel 1152. Specifically, the drive motor is preferably connected to the motor connection panel 1152 by bolts. The use of the motor connection panel 1152 helps improve connection stability of the drive motor 151 to the rear frame 115, beneficial for improving the working stability of the drive motor 151.

FIG. 5 shows the preferred layout relationship between rear shock absorbers 1321 of the suspension system 13 relative to the power battery 16 and the drive motor 151. In side view, the rear shock absorbers 1321 at least partially overlap with the power battery 16. As such, the rear shock absorbers 1321 help protect the power battery 16 from side impact, reducing the likelihood of damage to the power battery 16 during driving, beneficial for improving service life of the power battery 16.

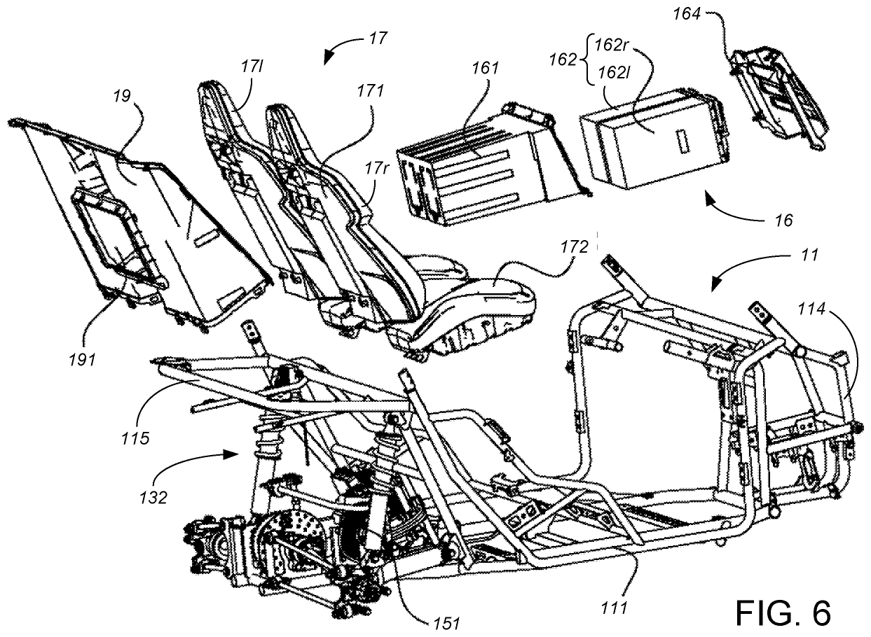

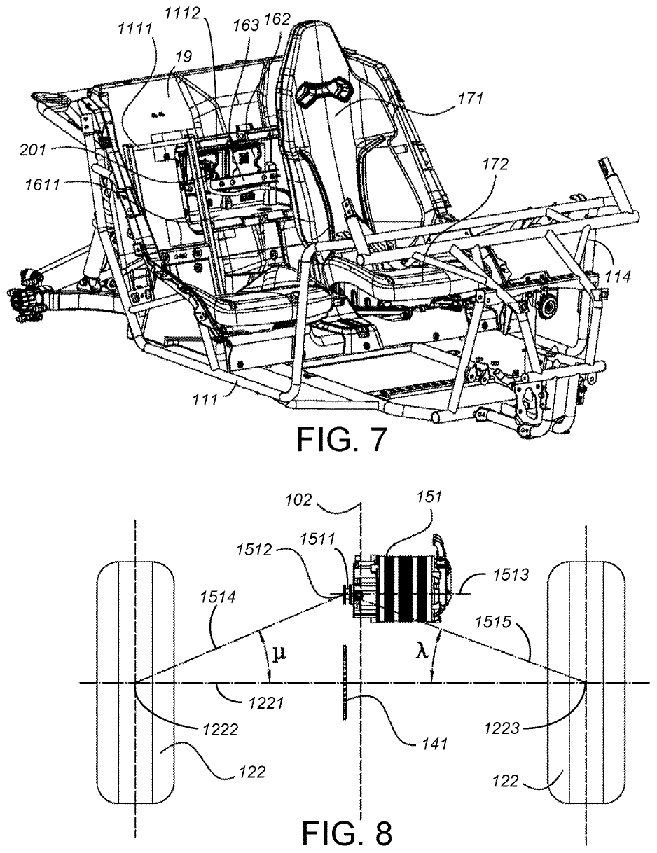

As shown in FIG. 6, the seating 17 preferably includes two side-by-side seats 17l, 17r each having a backrest 171 and a seat bottom cushion 172. For each of the seats 17l, 17r, the backrest 171 and the seat bottom cushion 172 are each detachably connected to a seat frame 1111 of the middle frame 111 best shown in FIG. 7. When viewed from the length direction of the off-road vehicle 100, the backrests 171 at least partially overlap with the power battery 16. However, a battery removal gap 1112 is provided between the left and right seat frames 1111. When the backrests 171 are removed, the power battery 16 can be removed from or reassembled into the rear frame 115 through the battery removal gap 1112. The battery removal gap 1112 facilitates assembly, disassembly, replacement and maintenance of the power battery 16.

The off-road vehicle 100 preferably includes a back panel 19, which defines a rear extent of the cockpit 112. The back panel 19 is preferably molded from plastic. The back panel 19 is connected or clamped to the frame 11, at least partially positioned between the power battery 16 and the seating 17. That is, the exploded view of FIG. 6 shows the power battery 16 in front of the back panel 19 and seating 17, but after assembly the power battery 19 is behind the seating 17 and substantially behind the back panel 19. The back panel 19 helps prevent heat generated by the power battery 16 from being transferred to the cockpit 112, thereby improving comfort of the driver and passengers sitting on the seating 17.

A maintenance opening 191 for the power battery 16 is formed on the back panel 19. When viewed from the length direction of the off-road vehicle 100, the maintenance opening 191 at least partially overlaps with the backrests 171. The power battery 16 can be accessed through the maintenance opening 191, which facilitates the replacement and maintenance of the power battery 16, improving the ease of assembly and removal of the power battery 16 into or from the vehicle 100.

The preferred power battery 16 includes a battery housing 161 and two battery modules 162 positioned in the battery housing 161 as shown in FIG. 6. The two battery modules 162 are preferably arranged side by side with one battery module 162l on the left and another battery module 162r on the right. When viewed from the length direction of the off-road vehicle 100, the backrest 171 of the driver seat 17l overlaps with the left battery module 162l and the backrest 171 of the passenger seat 17r overlaps with the right battery module 162r. Through the above arrangement, one of the battery modules 162 can be assembled and removed by removing the corresponding (left or right) backrest 171, thereby improving the replacement efficiency of either of the battery modules 162l, 162r.

The battery housing 161 connects to the back panel 19 and the frame 11. The preferred battery housing 161 covers and protects the top, left, rear, right and bottom sides of the battery modules 162, such that an opening 1611 (called out in FIG. 7) of the battery housing 161 is in communication with the maintenance opening 191. Fixing the battery housing 161 through the back panel 19 to the rear frame 115 is beneficial for improving the connection stability of the battery housing 161, thereby improving the working stability of the power battery 16.

The preferred power battery 16 includes a front fixing bracket or strap 163 as shown in FIG. 7. The fixing bracket or strap 163 is connected to the battery housing 161 for fixing the battery modules 162 into the battery housing 161. The preferred power battery 16 also includes a battery cover plate 164 as shown in FIG. 6. The battery cover plate 164 is used for covering the opening 1611 of the battery housing 161 and/or the maintenance opening 191 of the back panel 19, so that the battery cover plate 164 can further protect the battery modules 162. The battery cover plate 164 can be detachably connected to one or both of the battery housing 161 and/or the back panel 19.

The off-road vehicle 100 includes an electrical system 20 with a battery wiring harness 201 as called out in FIG. 7. The battery wiring harness 201 is electrically connected between the prime mover assembly 15 and one of the battery modules 162. The preferred battery wiring harness 201 can be detachably plugged into or unplugged from either battery module 162l, 162r. In addition to having detachable seat backs 171, the seating 17 is preferably longitudinally movable relative to the frame 11, such as by means of a slide rail (not independently shown) provided on the middle frame 111 for each of the left and right seats 17l, 17r. By moving the seating 17 forwardly, the user can disconnect the battery wiring harness 201 from one battery module 162 and then connect the battery wiring harness 201 to the other battery module 162. Thus, when one battery module 162 has been depleted to insufficient power, the prime mover assembly 15 can be switched and electrically draw electricity from the other battery module 162, thereby improving range of the off-road vehicle 100.

FIG. 8 shows a plan view of the drive motor 151 relative to the rear wheels 122. A longitudinal midplane 102 is defined as a plane perpendicular to the width direction of the off-road vehicle 100 and passing through the midpoint in the width direction between the two rear wheels 122. The longitudinal midplane 102 extends through the drive motor 151, with the drive motor 151 being forward of the rear wheel axis 1221. This location for the drive motor 151 places the center of gravity of the drive motor 151 close to the center of gravity of the off-road vehicle 100, improving stability of the off-road vehicle 100 during driving.

The drive motor 151 includes a drive motor output shaft 1511 with a drive motor output point 1512 defined where an end surface the drive motor output shaft 1511 intersects its rotational axis 1513. The preferred embodiment places the drive motor output point 1512 on a left side of the longitudinal midplane 102 as shown in FIG. 8, but an alternative embodiment can place the drive motor output point 1512 to the right of the longitudinal midplane 102, particularly when the left-right orientation of the drive motor 151 is flipped. Specifically, a first torque output transfer line 1514 is defined to run from the drive motor output point 1512 to a center point 1222 of one of the left or right rear wheels 122, while a second torque output transfer line 1515 is defined to run from the drive motor output point 1512 to a center point 1223 of the other of the left or right rear wheels 122. A first torque output angle μ is defined between the horizontal component of the first torque output transfer line 1513 and the rear wheel axis 1221. A second torque output angle λ is defined between the horizontal component of the second torque output transfer line 1514 and the rear wheel axis 1221. The first torque output angle μ and the second torque output angle λ are both acute. More specifically, the first torque output angle μ is preferably in the range of 16° to 30°, more preferably in the range of 19° to 27°, and most preferably about 23°. The second torque output angle λ is preferably in the range of 14° to 26°, more preferably in the range of 17° to 23°, and most preferably about 20°. The preferred values for the first and second torque output angles μ, λ help to balance the weight of the drive motor 151 while minimizing the length of the drive train 14 and maximizing layout efficiency.

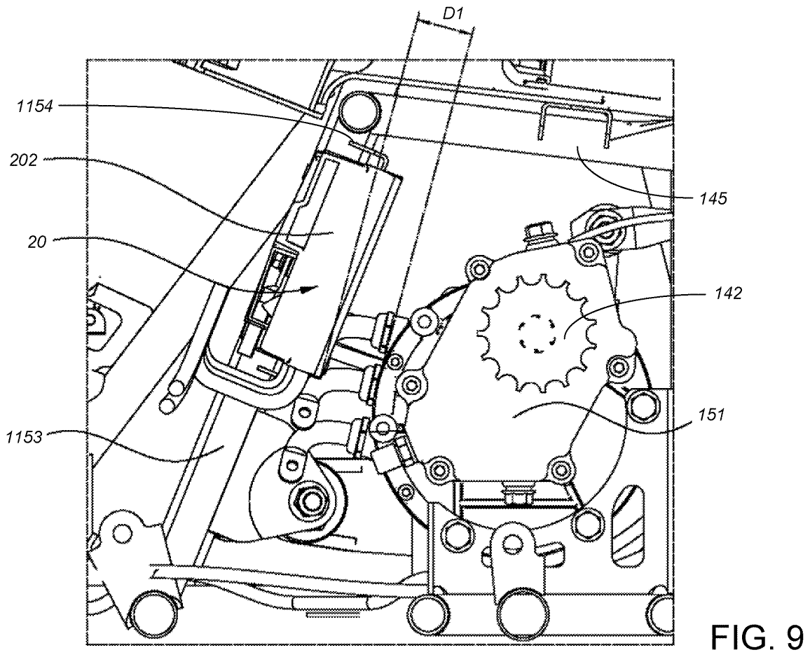

The electrical system 20 includes a motor controller 202 as shown in FIG. 3 and called out in FIG. 9 used to control output power of the drive motor 151. The motor controller 202 is supported by the frame 11 at least partially forward of the drive motor 151 and rearward of the seating 17, preferably on a slanted frame leg 1153 (called out in FIGS. 2 and 9) of the rear frame 115 and close to the drive motor 151. The slanted frame leg 1153 extends upwardly and rearwardly, and the preferred placement of the motor controller 202 is hung on a rear side of the slanted frame leg 1153, at least partially below at least part of the slanted frame leg 1153, locating the motor controller 202 at least partially in front of the power battery 16 and at least partially under of the power battery 16. The motor controller 202 can be hung using a sheet metal motor controller hanger 1154 or other connecting member. In addition, through the above arrangement for hanging the motor controller 202, the motor controller 202 can be separated from the drive motor 151 by a motor controller gap D1 defined as the minimum distance between the motor controller 202 and the drive motor 151. The motor controller gap D1 is preferably in the range of 19.7 mm to 36.7 mm, more preferably in the range of 23.9 mm to 32.5 mm, and most preferably about 28.2 mm. This location for hanging the motor controller 202 and preferred value for motor controller gap D1 minimizes length of the wiring harness (not shown) between the motor controller 202 and the drive motor 151 while maximizing layout efficiency without adding additional frame members, and also helping keep heat from the drive motor 151 from causing overheating of the motor controller 202, improving service life of the motor controller 202.

The preferred drive train 14 includes a rear axle sprocket 141 coupled to a drive motor sprocket 142 on the output shaft 1151 of the drive motor 151 through a chain (not shown), and torque output by the drive motor 151 is be transmitted to the rear wheels 122 via the rear axle sprocket 141, thereby enabling the rear wheels 122 to drive the off-road vehicle 100 to move. In plan view, the power battery 16 at least partially overlaps with the rear axle sprocket 141. An alternative embodiment uses a belt drive (not shown) in transferring torque from the drive motor 151 to the rear wheels 122. Chain drives and belt drives both allow for easy replacement and maintenance. Another alternative embodiment uses a rear drive shaft (not shown) in transferring torque from the drive motor 151 to the rear wheels 122.

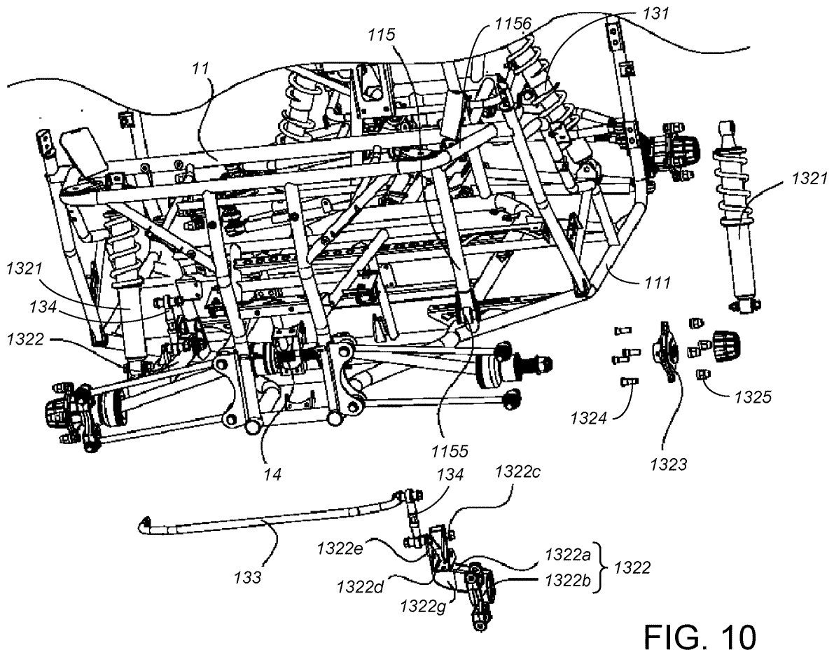

FIG. 10 shows the preferred rear suspension 132, with the right side of the rear suspension 132 exploded to better show different parts. Each left and right side of the rear suspension 132 includes a swing arm 1322 pivotally connected at its front end to the rear frame 115. The rear end of each swing arm 1322 rotatably supports a rear wheel hub 1323. Each rear wheel 122 is fixed to its associated left or right rear wheel hub 1323 such as by lugs 1324 and lug nuts 1325.

Each swing arm 1322 includes a swing arm main body 1322a and a wheel axle support 1322b welded to the rear end of the swing arm main body 1322a. Welding the wheel axle support 1322b to the swing arm main body 1322a simplifies processing of the swing arm 1322, reducing labor costs. Furthermore, welding the wheel axle support 1322b to the swing arm main body 1322a facilitates inspection of dimensional accuracy of the swing arm 1322 to reduce assembly errors, thereby improving the controllability of the position and angle of the swing arm 1322 to meet different assembly requirements of the rear wheels 122 and the drive train 14.

The front end of each swing arm 1322 has a bearing seat 1322c fixedly connected to the swing arm main body 1322a such as by welding. A connecting member such as a ball stud 1155 is fixed to the rear frame 115 to facilitate pivotal connection between the bearing seat 1322c and the rear frame 115.

Each swing arm main body 1322a includes a shock absorber mount 1322d for the associated rear shock absorber 1321. The rear shock absorber 1321 is pivotally attached to the shock absorber mount 1322d, extending upwardly to a pivotally attachment with a shock absorber frame mount 1156 on the rear frame 115, providing resistance and dampening to the pivotal movement of the swing arm main body 1322a. The shock absorber mount 1322d is preferably bolted onto the swing arm main body 1322a in any of a plurality of longitudinal positions. By having a plurality of potential longitudinal positions of the shock absorber mount 1322d on the swing arm main body 1322a, the rear shock absorber position, length and resistance force profile can be adjusted according to actual needs (such as for different drivers of different weights, but also including for use on other, different model vehicles), simply by moving the shock absorber mount 1322d relative to the swing arm main body 1322a. Alternative embodiments weld the shock absorber mount 1322d in a single, fixed position on the swing arm main body 1322a.

The off-road vehicle 100 includes a brake system 21 called out in FIG. 1, which is preferably a hydraulic brake system. The swing arm 1322 preferably includes one or more brake fluid pipeline mount(s) (not shown) for fixing a brake fluid pipeline (not shown) to the swing arm main body 1322a. Using brake fluid pipeline mount(s) on the swing arm main body 1322a reduces the need for additional mounting structures for the brake fluid pipeline.

The suspension system 13 preferably includes a transversely-extending rear stabilizer or sway bar 133 and two (left and right) sway bar linkages 134. The sway bar 133 is rotatably mounted on the rear frame 115 for limited rotation about a transverse axis, torsionally transferring force from suspension travel on one right or left rear wheel 122 to the other. The sway bar linkages 134 connect right and left ends of the sway bar 133 to sway bar linkage mounts 1322e on the wheel axle support 1322b of the respective right or left swing arm main body 1322a.

The shock absorber mounts 1322d, the brake fluid pipeline mounts and the sway bar linkage mounts 1322e may all be configured as sheet metal parts, thereby facilitating processing and meeting layout requirements.

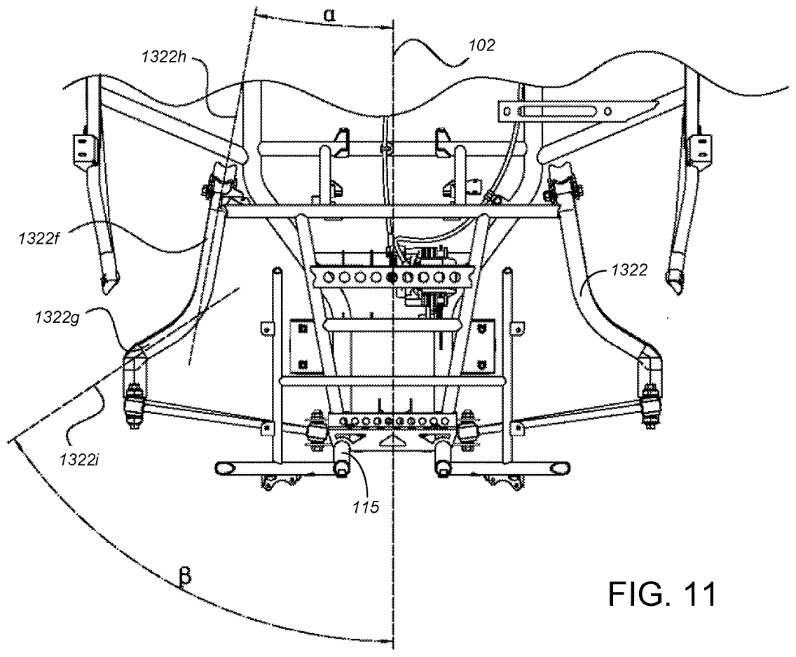

Each swing arm main body 1322a is preferably formed by bending a steel tube, with the bending location dividing the swing arm main body 1322a into a forward portion 1322f and a rearward portion 1322g as called out in FIG. 11. Both the forward portion 1322f and the rearward portion 1322g of the swing arm main body 1322a extend rearwardly and outwardly on the off-road vehicle 100, with the forward portion 1322f extending more longitudinally than the rearward portion 1322g. The forward portion 1322f extends substantially along a forward portion swing arm centerline 1322h, and the rearward portion 1322g extends substantially along a rearward portion swing arm centerline 1322i. A forward swing arm angle α is defined between the forward portion swing arm centerline 1322h and the longitudinal midplane 102, and a rearward swing arm angle β is defined between the rearward portion swing arm centerline 1322i and the longitudinal midplane 102. The forward swing arm angle α is preferably in the range of 7° to 15°, more preferably in the range of 9° to 13°, and most preferably about 11°. The rearward swing arm angle β is greater than the forward swing arm angle α, and preferably at least 24° greater than the forward swing arm angle α. More specifically, the rearward swing arm angle β is preferably in the range of 39° to 73°, more preferably in the range of 47° to 65°, and most preferably about 56°. Using a bend in each of the swing arms 1322 with the forward swing arm angle α and the rearward swing arm angle β each in the preferred ranges provides optimal layout for the suspension motion and forces carried by the swing arms 1322, while bending the swing arm main bodies 1322a out of steel tubing is a low cost and efficient manufacturing process.

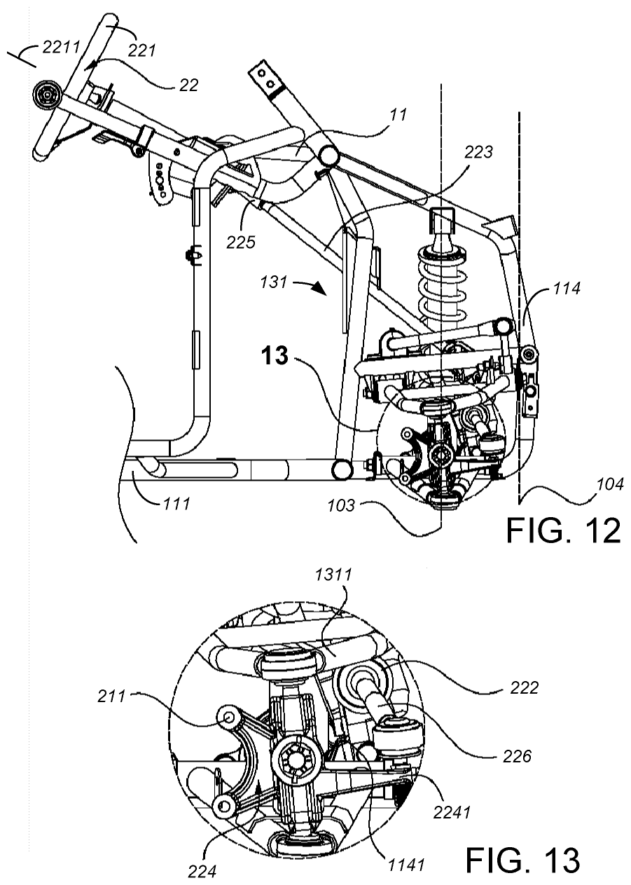

The off-road vehicle 100 includes a steering system 22 best shown in FIGS. 12-14, which is used by the driver to control direction of movement of the off-road vehicle 100. The preferred steering system 22 includes a steering wheel 221 rotatable about a steering wheel axis 2211 and coupled to a steering gearset 222 (such as a rack and pinion gearset) through a steering shaft 223. The steering gearset 222 is drivingly connected to a steering knuckle 224 for each of the front wheels 121, so that rotation of the steering wheel 221 and steering shaft 223 can drive the front wheels 121 to steer via the steering gearset 222.

As called out in FIG. 12, a front wheel axis plane 103 is defined as a plane perpendicular to the length direction of the off-road vehicle containing the front wheel axis 1211. The steering gearset 222 is positioned forwardly of the front wheel axis plane 103. This forward positioning of the steering gearset 222 provides more room adjacent the cockpit 112. If, instead of the rear-wheel drive off-road vehicle 100 depicted, the off-road vehicle 100 is front-wheel drive or more preferably four-wheel drive, this forward positioning of the steering gearset 222 also provides more room for a front drive shaft (not shown) and a front axle mechanism such as a front differential (not shown). This forward positioning of the steering gearset 222 also allows the steering shaft 223 to extend further longitudinally, at a more similar angle to the steering wheel axis 2211, which provides for more accurate steering of the off-road vehicle 100 with a smaller angle at a steering column universal joint 225, while still allowing a structurally compact steering system 22.

The preferred front suspension 131 includes left and right front upper rocker arms 1311 providing part of the connection between the front wheels 121 and the frame 11. The front wheels 121 move up and down via pivoting of the front rocker arms 1311 during the operation of the off-road vehicle 100. A suspension front plane 104 is defined as a plane perpendicular to the length direction of the off-road vehicle 100 and passing through the front extent of the front upper rocker arms 1311. The steering gearset 222 is positioned rearward of the suspension front plane 104, improving space utilization on the front frame 114 and increasing structural compactness of the front end of the off-road vehicle 100.

The steering gearset 222 is connected to the frame 11 via a steering gearset mount 1141. In side view such as shown in FIGS. 12 and 13, the steering gearset mount 1141 at least partially overlaps with the front rocker arms 1311. The steering gearset mount 1141 is preferably formed from sheet metal and is fixed to the front frame 114 such as by welding or by bolts.

Each steering knuckle 224 connects to a steering tie rod 226 at a steering arm connection seat 2241, with the steering tie rods 226 being driven by the steering gearset 222. The steering arm connection seats 2241 and the entirety of the steering tie rods 226 are located forward of the front wheel axis plane 103 and rearward of the suspension front plane 104, for more stable connection between the steering gearset 222 and the steering knuckles 224.

Each steering knuckle 224 at least partially extends rearward to form at least one caliper seat 211 for the brake system 21. Brake calipers (not shown) are attached at the caliper seats 211 on the rear side of the steering knuckles 224. Attachment of a brake caliper on the rear side of the steering knuckle 224 reduces the number of components around the steering knuckle 224 and increases the windward area of the front brakes (not shown), which are beneficial for heat dissipation of the front brakes.

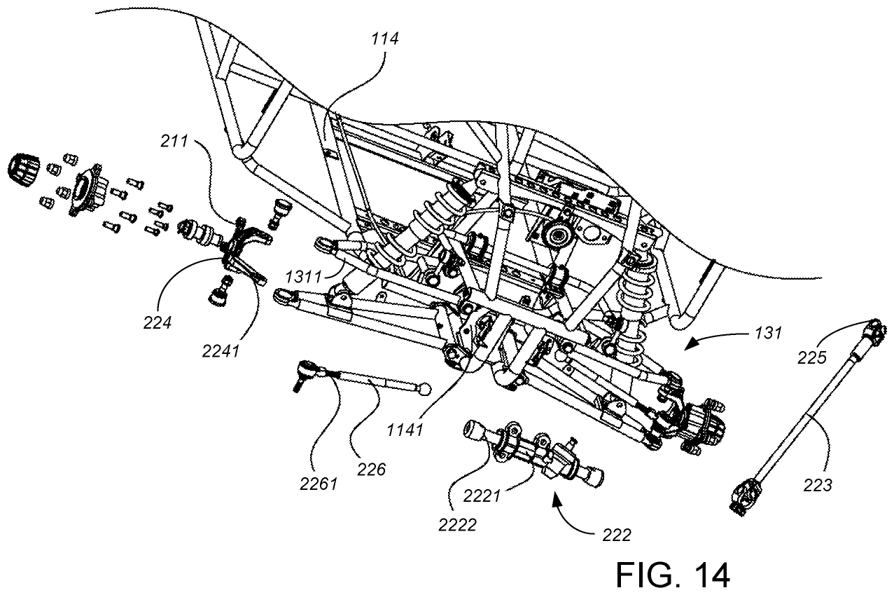

As best shown in FIG. 14, the steering gearset 222 preferably includes an outer housing 2221 with rack ends 2222 extending laterally outward from the outer housing 2221. Each steering tie rod 226 preferably includes a threaded length adjuster 2261 to fine-tune front wheel alignment (specifically toe-in or toe-out).

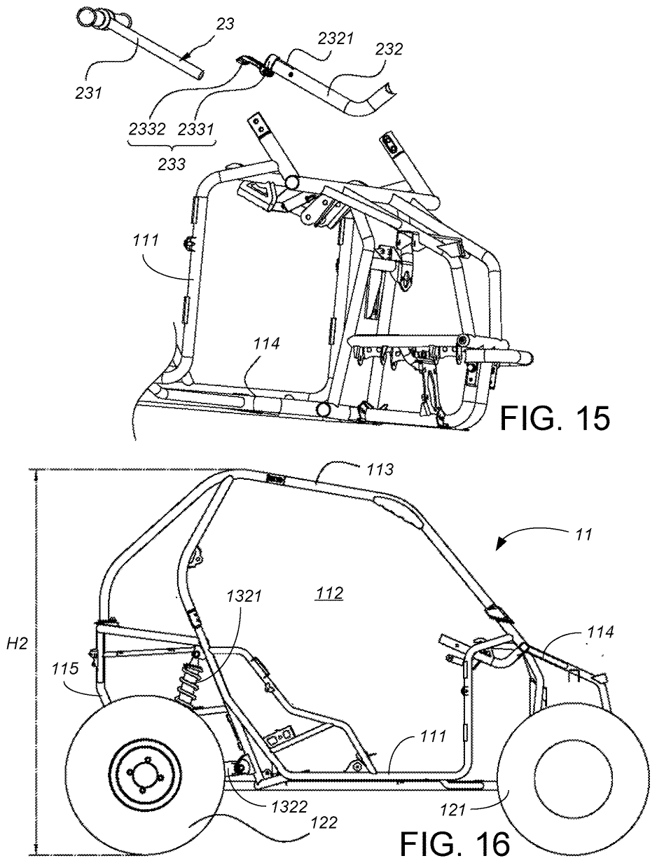

The preferred off-road vehicle 100 includes a passenger grabhandle 23 shown in FIG. 1 and best shown in FIG. 15. The passenger grabhandle 23 includes a grabhandle post 231 telescopingly received in a grabhandle sleeve 232, secured at a selected longitudinal position by a clamp 233. The grabhandle sleeve 232 is connected to the frame 11 such as by welding. The grabhandle sleeve 232 includes a longitudinally directed slit 2321, and the clamp 233 allows tightening of the grabhandle sleeve 232 around the grabhandle post 231 by compression of the longitudinally directed slit 2321 to reduce the inner circumference of the grabhandle sleeve 232. When the clamp 233 is loosened, the grabhandle post 231 is longitudinally movable relative to the grabhandle sleeve 232, so different users can adjust position of the passenger grabhandle 23 forwardly and rearwardly to meet their usage requirements. The preferred clamp 233 includes a collar 2331 and a cam lever 2332 for ease of clamping operation.

The preferred off-road vehicle 100 is quite compact, having a vehicle height H2 as shown in FIG. 16, measured at the top of the ROPS 113. The vehicle height H2 is preferably in the range from 1080 mm to 1620 mm, more preferably in the range from 1210 mm to 1490 mm, and most preferably about 1352 mm. Such sizing is particularly appropriate for an off-road vehicle 100 intended to be driven by a child.

It should be understood that those skilled in the art may make improvements or modifications based on the above description without departing from the concept of the present invention, and all such improvements and modifications shall fall within the protection scope of the appended claims. The above-described embodiments represent only a few embodiments of the present invention, and their descriptions are relatively specific and detailed, but should not be construed as limiting the scope of the appended claims.

1. An off-road vehicle, comprising
a frame having a middle frame at least partially defining a cockpit, and a front frame forward of the middle frame and a rear frame rearward of the middle frame;
seating supported by the middle frame;
a plurality of wheels supporting the frame and comprising front wheels and rear wheels;
a suspension system, the front wheels and the rear wheels connected to the frame by the suspension system;
a prime mover assembly supported by the rear frame, the prime mover assembly comprising a drive motor coupled to transmit torque to at least one of the front wheels and the rear wheels;
a power battery supported by the rear frame and electrically connected to provide electricity to the drive motor of the prime mover assembly; and
a rear cargo area at least partially disposed on the rear frame;
wherein when viewed from a length direction of the off-road vehicle, both the power battery and the rear cargo area at least partially overlap with the seating;
wherein when viewed from a height direction of the off-road vehicle, the rear cargo area at least partially overlaps with the power battery and the drive motor, with the power battery at least partially positioned under the rear cargo area and the drive motor at least partially positioned under the power battery.

2. The off-road vehicle according to claim 1, wherein when viewed from the length direction of the off-road vehicle, the drive motor at least partially overlaps with the seating, and wherein the rear wheels define a rear wheel axis which is rearward of the drive motor.

3. The off-road vehicle according to claim 2, wherein a ground plane is defined as a plane perpendicular to height direction of the off-road vehicle at lowest ends of the plurality of wheels, wherein a projection of the power battery vertically onto the ground plane is defined as a power battery projection, a projection of the rear cargo area vertically onto the ground plane is defined as a cargo box projection, and a projection of the drive motor vertically onto the ground plane is defined as a drive motor projection, wherein a drive motor/cargo box area ratio of an area of the drive motor projection to an area of the cargo box projection is in the range from 0.06 to 0.13, and wherein a drive motor/power battery area ratio of an area of the drive motor projection to an area of the power battery projection is in the range from 0.14 to 0.27.

4. The off-road vehicle according to claim 3, wherein a power battery/cargo box area ratio of an area of the power battery projection to an area of the cargo box projection is in the range from 0.3 to 0.56.

5. The off-road vehicle according to claim 2, wherein a longitudinal midplane is defined as a plane perpendicular to width direction of the off-road vehicle and passing through a midpoint in the width direction between the rear wheels, wherein the longitudinal midplane extends through the drive motor.

6. The off-road vehicle according to claim 1, wherein a ground plane is defined as a plane perpendicular to height direction of the off-road vehicle at lowest ends of the plurality of wheels, wherein a minimum vertical distance between an upper surface of the power battery and the ground plane is defined as battery height, wherein when the off-road vehicle is moving and not turning the front wheels rotate generally about a front wheel axis the rear wheels rotate generally about a rear wheel axis, wherein horizontal distance from the front wheel axis to the rear wheel axis is defined as a wheelbase, and wherein a battery height/wheelbase ratio of the battery height to the wheelbase is in the range of 0.3 to 0.58.

7. The off-road vehicle according to claim 1, wherein the drive motor is coupled to transmit torque to the rear wheels through a rear axle sprocket, and wherein, when viewed from the height direction of the off-road vehicle, the rear axle sprocket at least partially overlaps with the power battery.

8. The off-road vehicle according to claim 1, wherein the suspension system comprises a rear shock absorber for each of the rear wheels, and when viewed from a width direction of the off-road vehicle, the shock absorbers at least partially overlap with the power battery.

9. The off-road vehicle according to claim 1, wherein the seating comprises at least one backrest detachably connected to the frame.

10. The off-road vehicle according to claim 9, wherein the off-road vehicle further comprises a back panel at least partially positioned between the power battery and the seating, the back panel having a maintenance opening defined therein for accessing the power battery while the backrest is removed.

11. The off-road vehicle according to claim 1, wherein the power battery comprises a battery housing and left and right battery modules positioned in the battery housing.

12. The off-road vehicle according to claim 11, wherein the off-road vehicle further comprises a wiring harness which can electrically connect the drive motor of the prime mover assembly either to the left battery module or to the right battery module.

13. An off-road vehicle, comprising
a frame having a middle frame at least partially defining a cockpit, and a front frame forward of the middle frame and a rear frame rearward of the middle frame;
seating supported by the middle frame;
a plurality of wheels supporting the frame and comprising front wheels and rear wheels;
a suspension system, the front wheels and the rear wheels connected to the frame by the suspension system;
a prime mover assembly supported by the rear frame, the prime mover assembly comprising a drive motor coupled to transmit torque to at least one of the front wheels and the rear wheels;
a power battery supported by the rear frame and electrically connected to provide electricity to the drive motor of the prime mover assembly;
a rear cargo area at least partially disposed on the rear frame; and
a back panel at least partially positioned between the power battery and the seating, the back panel having a maintenance opening defined therein for accessing the power battery;
wherein when viewed from a length direction of the off-road vehicle, both the power battery and the rear cargo area at least partially overlap with the seating;
wherein when viewed from a height direction of the off-road vehicle, the rear cargo area at least partially overlaps with the power battery, with the power battery at least partially positioned under the rear cargo area.

14. The off-road vehicle according to claim 13, wherein the seating comprises at least one backrest detachably connected to the middle frame, and wherein the maintenance opening allows installation or removal of the power battery while the backrest is removed.

15. The off-road vehicle according to claim 14, wherein the power battery comprises a battery housing and left and right battery modules positioned in the battery housing.

16. The off-road vehicle according to claim 15, wherein the off-road vehicle further comprises a wiring harness which can electrically connect the drive motor of the prime mover assembly either to the left battery module or to the right battery module.

17. The off-road vehicle according to claim 13, wherein when viewed from a height direction of the off-road vehicle, the rear cargo area at least partially overlaps with the drive motor, with the drive motor at least partially positioned under the power battery.

18. The off-road vehicle according to claim 13, further comprising a motor controller supported by the frame at least partially forward of the drive motor and rearward of the seating 17, The motor controller being hung from a slanted frame leg which extends upwardly and rearwardly.

19. The off-road vehicle according to claim 13, wherein the drive motor is coupled to transmit torque to the rear wheels through a rear axle sprocket, and wherein, when viewed from the height direction of the off-road vehicle, the rear axle sprocket at least partially overlaps with the power battery.

20. The off-road vehicle according to claim 13, wherein a longitudinal midplane is defined as a plane perpendicular to width direction of the off-road vehicle and passing through a midpoint in the width direction between the rear wheels, wherein the longitudinal midplane extends through the drive motor, wherein the suspension system comprises a rear suspension with swing arms for the rear wheels, each swing arm having a swing arm main body formed by bending a tube with a bending location dividing the swing arm main body into a forward portion and a rearward portion, wherein both the forward portion and the rearward portion of each swing arm main body extend rearwardly and outwardly on the off-road vehicle, wherein the forward portion extends substantially along a forward portion swing arm centerline and the rearward portion extends substantially along a rearward portion swing arm centerline, wherein a forward swing arm angle is defined between the forward portion swing arm centerline and the longitudinal midplane, wherein a rearward swing arm angle is defined between the rearward portion swing arm centerline and the longitudinal midplane, wherein the rearward swing arm angle is at least 24° greater than the forward swing arm angle.
